(19) United States
(12) Patent Application Publication
(10) Pub. No.: US 2024/0249525 A1
(43) Pub. Date: Jul. 25, 2024

(54) PROCESSING SYSTEM, CALCULATING DEVICE, PROCESSING METHOD, TRACKING METHOD, AND STORAGE MEDIUM

(71) Applicant: KABUSHIKI KAISHA TOSHIBA, Tokyo (JP)

(72) Inventors: Ryutaro YAMAGUCHI, Ichikawa (JP); Tsubasa KUSAKA, Yokohama (JP); Toshikazu TAKI, Ota (JP)

(73) Assignee: KABUSHIKI KAISHA TOSHIBA, Tokyo (JP)

(21) Appl. No.: 18/414,569

(22) Filed: Jan. 17, 2024

(30) Foreign Application Priority Data
Jan. 19, 2023 (JP) 2023-006835

(51) Int. Cl. G06V 20/52; G06T 5/50; G06T 7/20; G06V 10/74

(52) U.S. Cl. CPC G06V 20/52; G06T 5/50; G06T 7/20; G06V 10/761; G06T 2207/20221; G06V 2201/07

(57) ABSTRACT

A processing system includes an imaging part, a detecting part, an identifying part, a tracking part, and a calculator. The imaging part acquires an image by imaging a work site from above. The detecting part detects a person visible in the image and acquires a coordinate of the person in the image. The identifying part identifies the person and associates identification information with the detected person. The tracking part tracks the person associated with the identification information by using the coordinate. The calculator calculates a dwell time of the person in a work area set in the work site by using a result of the tracking.

### CROSS-REFERENCE TO RELATED APPLICATIONS

This application is based upon and claims the benefit of priority from Japanese Patent Application No. 2023-006835, filed on Jan. 19, 2023; the entire contents of which are incorporated herein by reference.

### FIELD

Embodiments described herein relate generally to a processing system, a calculating device, a processing method, a tracking method, and a storage medium.

### BACKGROUND

Conventionally, work time is recorded to manage work. For example, the time that a worker dwells in a work area in which work is performed is calculated. The dwell time is deemed to be the work time, and is recorded. Technology that can more easily acquire the dwell time is desirable.

### BRIEF DESCRIPTION OF THE DRAWINGS

FIG. 1 is a schematic view showing a configuration of a processing system according to an embodiment;

FIG. 2 is a schematic view illustrating a work site;

FIG. 3 is a schematic view showing an example of setting of a work area;

FIG. 4 is a schematic view showing an output example of the processing system according to the embodiment;

FIG. 5 is a flowchart showing a processing method according to the embodiment;

FIGS. 6A and 6B are schematic views for describing processing by the processing system according to the embodiment;

FIGS. 7A and 7B are schematic views for describing processing by the processing system according to the embodiment;

FIG. 8 is a schematic view showing a configuration example of the processing system according to the embodiment; and

FIG. 9 is a schematic view illustrating a hardware configuration.

### DETAILED DESCRIPTION

According to an embodiment, a processing system includes an imaging part, a detecting part, an identifying part, a tracking part, and a calculator. The imaging part acquires an image by imaging a work site from above. The detecting part detects a person visible in the image and acquires a coordinate of the person in the image. The identifying part identifies the person and associates identification information with the detected person. The tracking part tracks the person associated with the identification information by using the coordinate. The calculator calculates a dwell time of the person in a work area set in the work site by using a result of the tracking.

Embodiments of the invention will now be described with reference to the drawings. In the specification and drawings, components similar to those already described are marked with the same reference numerals; and a detailed description is omitted as appropriate.

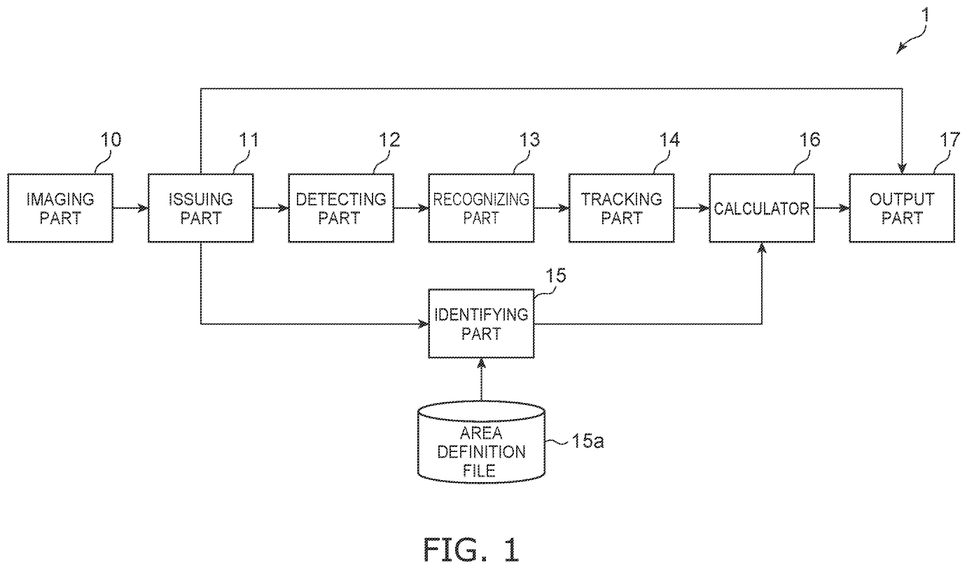

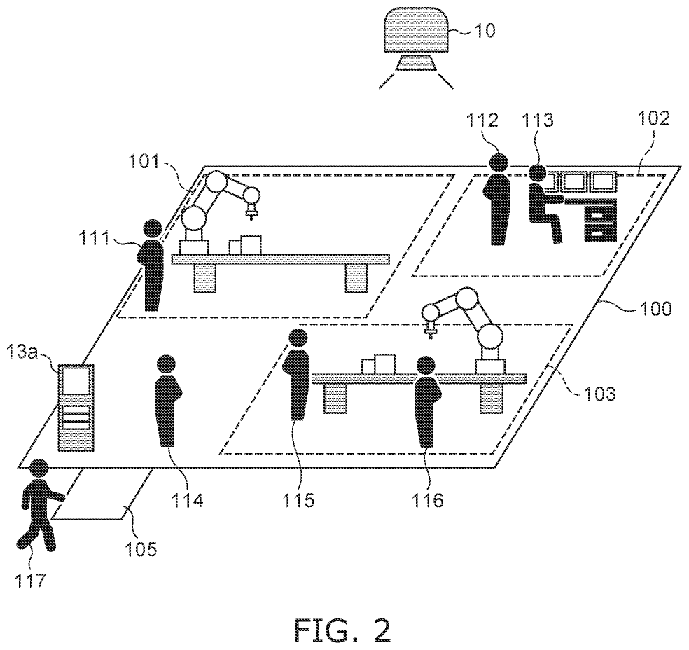

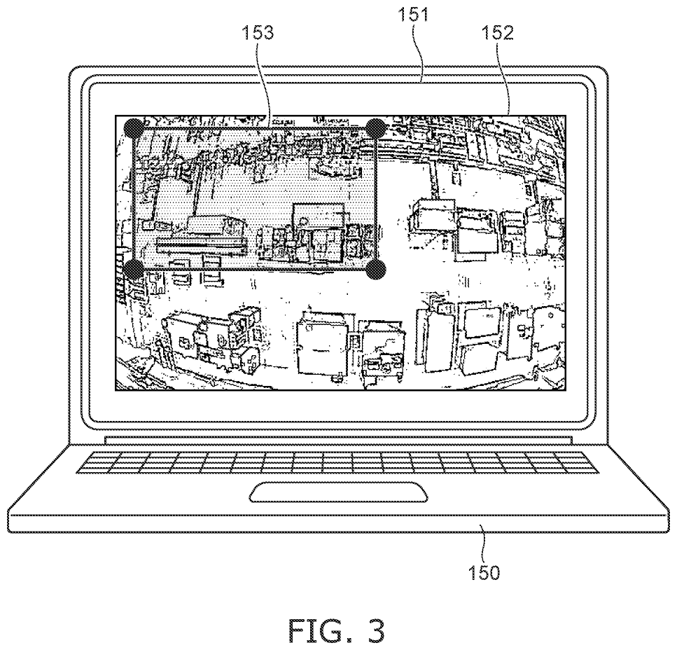

FIG. 1 is a schematic view showing a configuration of a processing system according to an embodiment. FIG. 2 is a schematic view illustrating a work site. FIG. 3 is a schematic view showing an example of setting of a work area.

As shown in FIG. 1, the processing system 1 according to the embodiment includes an imaging part 10, an issuing part 11, a detecting part 12, an identifying part 13, a tracking part 14, a recognizing part 15, a calculator 16, and an output part 17.

The imaging part 10 acquires an image by imaging the work site. The work site includes one or more work areas. For example, as shown in FIG. 2, multiple work areas 101 to 103 are set in a work site 100. Prescribed work is performed by workers in each work area. The imaging part 10 repeatedly acquires images at a prescribed interval. For example, the imaging part 10 acquires a video image.

When acquiring the images, it is favorable for the imaging part 10 to be mounted at a position higher than the body height of a person and to image the work site from above so that the person does not overlap an object or another person. Most favorably, the imaging part 10 is mounted to a ceiling or the like and images the work site in the vertical direction.

When an image is acquired by the imaging part 10, the issuing part 11 issues (transmits) the image so that other components can process the image.

The detecting part 12 detects the persons visible in the image. For example, workers performing work, supervisors supervising the work, visitors observing the work, etc., may be present in the work site. The detecting part 12 detects these persons visible in the image. A person detection model including a neural network can be used to detect. The detecting part 12 inputs the image to the person detection model; and the person detection model detects the persons visible in the image. The detecting part 12 also acquires the coordinates in the image of the detected person.

For example, when the imaging part 10 images the work site 100 shown in FIG. 2, persons 111 to 116 are visible in the image. The detecting part 12 detects each of the persons 111 to 116 visible in the image. The detecting part 12 also acquires the coordinates of each of the persons 111 to 116. The detecting part 12 transmits the detection result of the person and the acquisition result of the coordinates to the identifying part 13 and the tracking part 14.

The identifying part 13 identifies the persons. For example, the identifying part 13 includes a reading device (a reader) located at the entrance/exit of the work site. When a person enters the work site and exits the work site, an identifier that is associated with the person's data is read by the reading device. The identifier is a one-dimensional code (a barcode), a two-dimensional code (a QR code (registered trademark)), a radio frequency identification (RFID) tag, an IC chip, etc. For example, the person holds up to the reading device an employee identification card to which an identifier is mounted. The reading device reads identification information from the identifier and identifies the person entering the work site. The identification information includes a unique character string (ID), a name, etc., for designating the individual.

The identifying part 13 may read biological data. For example, the identifying part 13 includes a camera and images the face of the person. The identifying part 13 inputs the image of the face of the person to a discriminative model. The discriminative model classifies the face visible in the image. The identifying part 13 identifies the person based on the classification result of the discriminative model. Other than a face, the identifying part 13 may be a reading device that can acquire biological data such as a fingerprint, vein, iris, voice, etc., and may identify the person based on any biological data.

The identifying part 13 associates the identification information of the person detected by the detecting part 12 with the person. As a specific example as shown in FIG. 2, a person 117 passes through an entrance/exit 105 of the work site 100 when entering the work site. A reading device 13a of the identifying part 13 is located at the entrance/exit 105. The reading device 13a is positioned within the angle of view of the imaging part 10. The person 117 holds the employee identification card up to the reading device 13a of the entrance/exit 105. The reading device 13a reads the identifier of the employee identification card and identifies the person 117. At this time, the person 117 is imaged by the imaging part 10 and detected by the detecting part 12. When the reading device 13a reads the identifier, the identification information is associated with the person 117 most proximate to the reading device 13a among the persons detected by the detecting part 12.

The tracking part 14 tracks the person by using the detection result of the person and the acquisition result of the coordinates from the detecting part 12. Specifically, the tracking part 14 calculates a feature of the detected person in an image acquired in one frame among multiple images acquired continuously. Then, the tracking part 14 calculates the feature of the detected person in an image acquired in the immediately following frame. The tracking part 14 calculates the feature difference and the coordinate difference (the distance) between the person detected in the one frame and the person detected in the immediately following frame. When the feature difference is less than a prescribed threshold and the distance is less than a prescribed threshold, the tracking part 14 determines that the same person is visible in the images. When multiple persons are visible in the images, tracking is performed for each person.

The tracking part 14 performs tracking each time an image is acquired. Also, the identifying part 13 associates identification information with the detection result of the person. Therefore, the person can be tracked in a state in which the person is identified.

The recognizing part 15 recognizes the work areas included in the work site. For example, markers that indicate the work areas are located in the work site. Markers such as colored poles that are colored differently from the surroundings, AR markers, etc., can be used. For example, when the work area is polygonal, a marker is located at each corner. The recognizing part 15 detects features corresponding to the markers from the image and measures the coordinates of the markers in the image. The recognizing part 15 recognizes the work area from the measured coordinates. It is favorable to provide the markers at positions that are easily visible in the image and do not overlap persons or objects. For example, markers are located on shelves, at the upper ends of poles, etc.

Instead of markers, the coordinates of the work area may be preset. The work area is defined using the coordinates in the image acquired by the imaging part 10. The coordinates of the work area are stored as an area definition file 15a. When the image is issued by the issuing part 11, the recognizing part 15 recognizes the work area in the image according to the coordinates stored in the area definition file 15a. The recognizing part 15 transmits the recognition result of the work area to the calculator 16.

Special-purpose software can be used to set the coordinates of the work area. For example, as shown in FIG. 3, a graphical user interface (GUI) 151 is displayed by a terminal device 150 in which software is installed. The output part 17 may function as the terminal device 150 that displays the GUI 151. The GUI 151 displays an image 152 acquired by the imaging part 10. The user can draw a work area 153 on the GUI by using an input device such as a mouse, touchpad, pen tablet, etc. The terminal device 150 sets the coordinates of the work area 153 based on the drawn work area 153. The terminal device 150 stores the set coordinates in the area definition file 15a.

The calculator 16 calculates the dwell time of the person in the work area by using the recognition result of the work area and the result of the tracking. The dwell time is calculated for each work area and for each person. The calculator 16 determines that the person acquired by the detecting part 12 dwells in a work area when the coordinates of the person are inside the recognized work area. The calculator 16 tabulates the time that the persons dwell in the work area and calculates the total time as the dwell time.

Prescribed work is performed in each work area. The dwell time in the work area can be deemed to be work time during which some work was performed. The work area and the work performed in the work area may be pre-associated. In such a case, the dwell time in the work area can be deemed to be the work time of the work associated with the work area.

For example, when a work area is defined by drawing on the GUI, the work that is performed in the work area is associated on the same GUI. When the work area is recognized using markers, the work area and the work to be performed are associated by using different markers for each work to be performed. For example, when colored poles are used as the markers, at least a part of each pole is colored differently for each work. When AR markers are used, the AR marker information such as codes and the like are different for each work.

The output part 17 externally outputs the calculated dwell time. For example, the output part 17 writes the calculated dwell time in an external database. The output part 17 may output the dwell time of each work area to a prescribed output device. The output part 17 may transmit the dwell time to a higher-level system for managing the work.

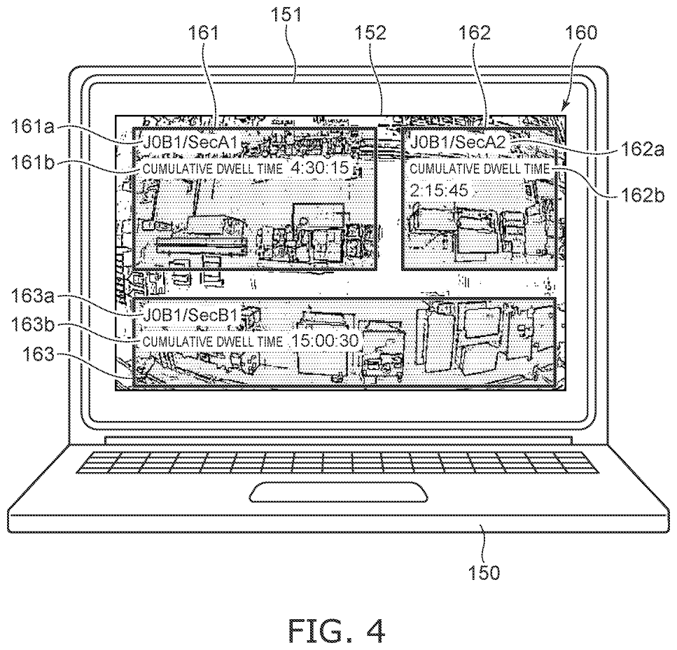

FIG. 4 is a schematic view showing an output example of the processing system according to the embodiment.

For example, the output part 17 outputs the image of the work site, objects indicating work areas, and dwell times in the work areas. In the example shown in FIG. 4, the image 152 is displayed by the GUI 151 of the terminal device 150. There are three work areas in a work site 160 visible in the image 152. Rectangular objects 161 to 163 that indicate the three work areas are displayed by being overlaid on the image 152.

Work IDs 161a to 163a that indicate the work to be performed in each work area and cumulative dwell times 161b to 163b are displayed respectively inside the objects 161 to 163. In the example, the cumulative dwell time indicates the total dwell time of all persons dwelling in the work area. The identification information and dwell times of the persons dwelling in each work area may be displayed individually.

The user can easily ascertain the work time necessary for each work by displaying the work areas overlaid on the image of the work site and by displaying the dwell times associated with the work areas.

The processing system 1 may display a video image acquired by the imaging part 10 on the GUI 151. In such a case, the objects 161 to 163, the work IDs 161a to 163a, and the dwell times 161b to 163b are displayed on the video image. The dwell times 161b to 163b may increase according to the transition of the acquisition time of the displayed image. The GUI 151 may display a real-time video image acquired by the imaging part 10.

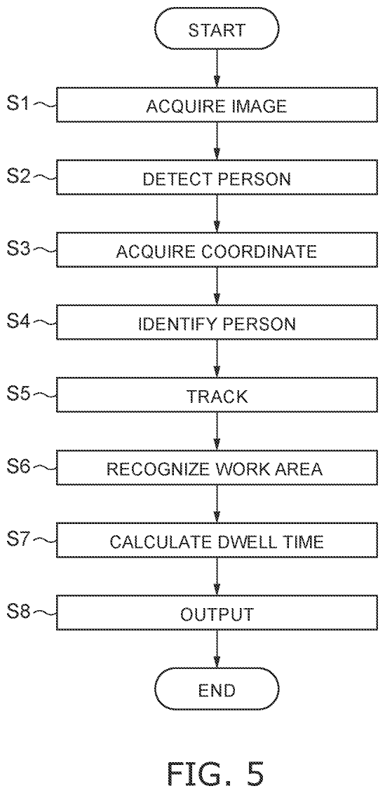

FIG. 5 is a flowchart showing a processing method according to the embodiment.

First, the imaging part 10 acquires the image of the work site (step S1). When the image has been issued by the issuing part 11, the detecting part 12 detects the persons visible in the image (step S2). The detecting part 12 also acquires the coordinates of the detected persons (step S3). The identifying part 13 identifies persons entering the work site (step S4). The tracking part 14 associates identification information with the persons detected from the image and tracks the persons (step S5). The recognizing part 15 recognizes the work areas in the image (step S6). The calculator 16 calculates the dwell times of the persons in the work areas based on the result of the tracking and the recognition result of the work areas (step S7). The output part 17 outputs the calculation result of the dwell times (step S8).

Advantages of the embodiment will now be described.

Conventionally, work times are recorded to manage the work. Various methods are employed to more easily tabulate work times. For example, in a first method, an identifier such as a barcode, a RFID tag, or the like is located in each work area.

The worker reads an identifier when starting work and when ending work. The difference between the start time and the end time is tabulated as the dwell time of the work area. In a second method, multiple sensors are attached to the worker; and the detected values of the sensors are used to estimate the work area in which the worker dwells, the work performed, etc. The dwell time in each work area, the work time of the work, etc., are tabulated based on the estimation result. In a third method, an indoor positioning system is used. Namely, a transmitter such as a beacon or the like is attached to the worker; and an antenna (a receiver) is installed in the work site. The position of the worker is estimated based on the direction and strength of the radio wave emitted from the transmitter; and the dwell times of the work areas are tabulated using the estimated position.

In the first method, it takes time and effort for the worker to read the identifier. Also, if the worker forgets to read the identifier, the dwell time is not tabulated correctly. It is also possible for the worker to intentionally change the start time or the end time. In the second method, the attachment of the sensor may be a burden to the worker. Also, maintenance of the sensors is necessary, which increases the management burden. In the third method, the preparation of the transmitters and the receivers takes time and effort and incurs high costs.

For these problems, according to the invention according to the embodiment, the image of the work site is used to calculate the dwell time. To obtain the image, it is sufficient to mount the imaging part 10, which requires little time and effort. Also, the imaging part 10 images the work site from above and therefore does not easily obstruct the work. By imaging the work site from above, the persons visible in the image are not easily concealed by shadows. Therefore, the accuracy of the dwell time calculated based on the image can be increased.

When the image is acquired, the persons visible in the image are detected, and the coordinates of the persons are acquired. The persons that are visible in the image are identified and associated with detection information. An identifier or biological data can be used to identify the person. In particular, systems for work sites that use an employee identification card or the like to identify persons entering the work site and persons exiting the work site are widely used. By using an existing identification system, the time and effort for implementing the invention according to the embodiment can be reduced.

After the identification information is associated with the detection result of the person, the person is tracked using multiple images. The dwell times of the persons in the work areas set in the work site can be calculated using the tracking result.

According to the invention according to the embodiment, compared to the first to third methods, the dwell times of the persons in the work areas can be acquired more easily and with less time and effort. According to the invention according to the embodiment, each person in the work site can be identified, and so the dwell time in each work area can be acquired for each person.

The work area for which the dwell time is calculated can be recognized from the image. To recognize the work areas, markers are mounted or coordinates are designated. The markers may be located according to the actual work areas. For example, the coordinates of the work areas can be designated using an application such as that shown in FIG. 4. Therefore, the necessary time and effort is less than when various sensors, an indoor positioning system, etc., are prepared.

The invention according to the embodiment is especially favorable for production sites of indent-type (individual-order production) products. Indent-type products have different specifications for each product. Therefore, the work is different when producing each product. The layout of the work site also is modified as appropriate according to the product. According to the invention according to the embodiment, the work areas for which the dwell times are calculated can be easily modified by moving the markers or modifying the coordinates. It is therefore easy to adapt to layout modifications of the work site. By modifying the work associated with the work area, it is also easy to adapt to the addition, modification, or deletion of work.

To further increase the accuracy of the dwell time, it is most favorable for the imaging part 10 to image the work site from the vertical direction. When the work site is imaged from the vertical direction, the persons are not easily concealed by shadows compared to when the work site is imaged from obliquely upward. Therefore, the person detection accuracy of the detecting part 12 can be increased.

In a work site, there are cases where persons are positioned higher than the floor surface. When imaged from the vertical direction, the persons are displayed as overlapping the floor surface directly below in the depth direction of the image regardless of the position of the person in the height direction. On the other hand, when imaged from obliquely upward, a person may be displayed as overlapping the floor surface at another location in the depth direction of the image. When imaging the work site from the vertical direction, the difference between the actual coordinates of the person and the coordinates of the person acquired from the image can be less than when the work site is imaged from obliquely upward. Even when markers are located at high positions, the positional misalignment of the actual work area and the recognized work area can be reduced by imaging the work site from the vertical direction. By imaging the work site from the vertical direction, the detection accuracy of the persons, the accuracy of the positions, the recognition accuracy of the work area, etc., can be increased, and the dwell time can be calculated with higher accuracy.

More desirable specific examples of the invention according to the embodiment will now be described.

When a large article is manufactured in the work site, there are cases where a person is concealed in the shadow of the article and is no longer visible in the image. For example, the person is not visible in the image while the person works under the article. As a result, the person that had been tracked up to that time is no longer tracked. In other words, lost tracking occurs. The dwell time is not calculated for the person that is lost and not tracked. To increase the accuracy of the dwell time, it is desirable to be able to correctly recover from the lost tracking state when the concealed person reappears. In other words, it is desirable to restart the tracking of the person that reappeared and to reassociate the identification information with the tracked person.

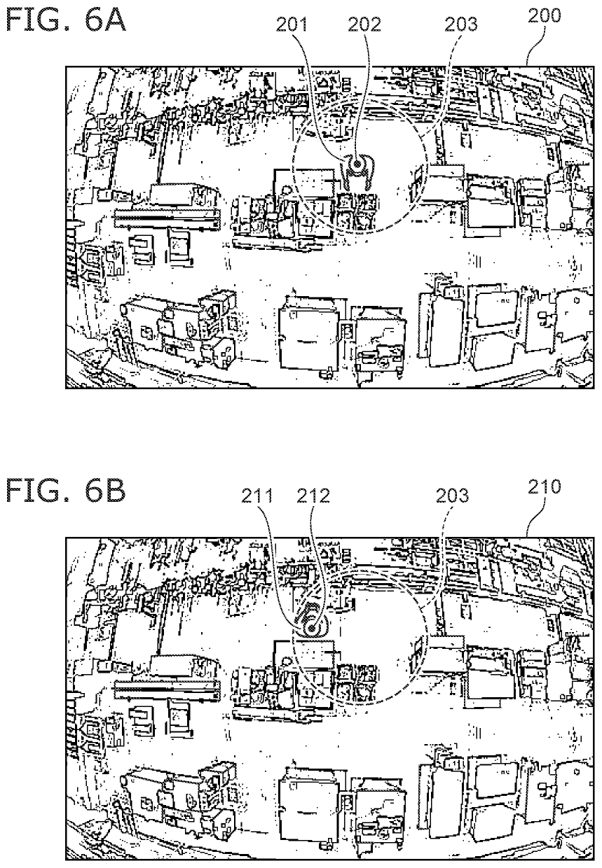

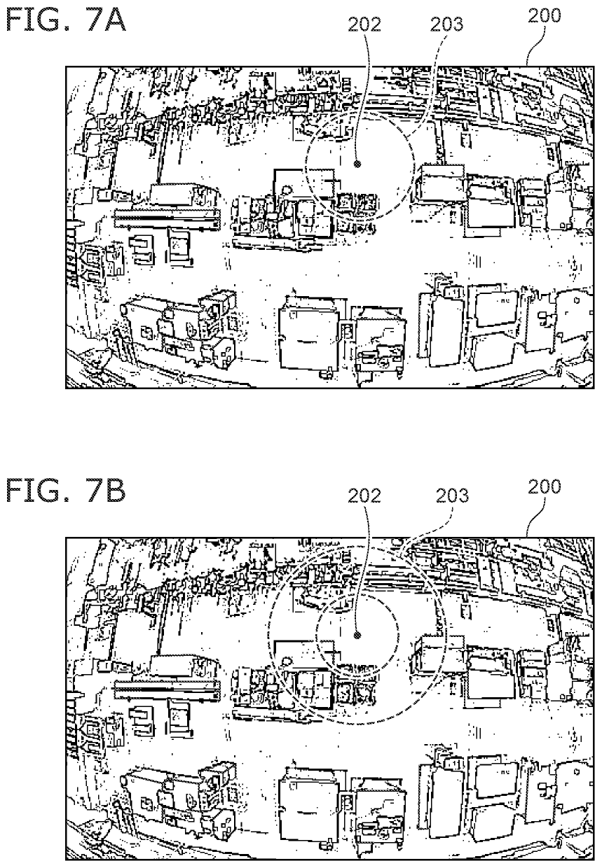

FIGS. 6A, 6B, 7A, and 7B are schematic views for describing processing by the processing system according to the embodiment.

When lost tracking occurs, the tracking part 14 performs recovery processing (a recovering method) to recover from this state. Specifically, when a person who was being tracked in one image (a second image) is not detected, the tracking part 14 refers to a previous image (a first image) in which the person was last detected. FIG. 6A is an example of a previous image 200. The tracking part 14 sets a search range 203 referenced to coordinates 202 of a person 201 in the previous image 200. The size of the search range 203 is preset according to the size of the work area, the size of the articles handled in the work site, etc.

Subsequently, as shown in FIG. 6B, when a person 211 is visible in a subsequent image 210 (a third image) acquired after the previous image 200, the detecting part 12 detects the person 211. The detecting part 12 also acquires coordinates 212 of the person 211. The person 211 is not associated with identification information because the person 211 was not tracked up to that point. The tracking part 14 determines whether or not the coordinates 212 are inside the search range 203. The tracking part 14 also calculates the time difference between the acquisition time of the previous image 200 and the acquisition time of the subsequent image 210 and compares the time difference with a prescribed threshold. When the coordinates 212 are inside the search range 203 and the time difference is less than the threshold, the tracking part 14 determines that the person 211 visible in the subsequent image 210 is the same as the person 201 visible in the previous image 200. The tracking part 14 associates the identification information of the lost person with the person 211 detected by the subsequent image 210, and restarts the tracking.

According to this processing, tracking associated with the identification information can be restarted even when lost tracking occurs. In particular, it is common for a person to continuously work within a specific area of the work site. Therefore, even when lost tracking occurs, the tracking can be restarted with high accuracy by searching the vicinity of the coordinates directly before being lost.

The tracking part 14 determines that lost tracking has occurred when the state of being unable to track continues for a prescribed period or more. As an example, the detecting part 12 detects five times per second. The detecting part 12 detects a person in an image acquired directly before starting the detection. When one person cannot be tracked ten consecutive times, the tracking part 14 determines that lost tracking has occurred. In other words, the prescribed period is set to 2 seconds. When it is determined that lost tracking has occurred, the tracking part 14 performs recovery processing.

To further increase the tracking accuracy when lost tracking has occurred, the tracking part 14 may perform a first determination or a second determination, which are described below.

In the first determination, the tracking part 14 calculates the movement speed of the person directly before lost tracking occurred. The movement speed is calculated based on the time difference between when multiple images were acquired and the difference between the coordinates of the person in the images.

For example, the movement speed can be calculated using the acquisition time of the previous image 200, the coordinates of the person in the previous image 200, the acquisition time of the image acquired directly-previous, and the coordinates of the person in the directly-previous image. When the directly-previous movement speed is less than a preset threshold, the tracking part 14 determines that the person is concealed in a shadow. When the person is determined to be concealed in a shadow in the first determination, the tracking part 14 performs the recovery processing.

In the second determination, the tracking part 14 refers to the coordinates of the article in the work site and the coordinates of the person directly before lost tracking occurred. The coordinates of the article may be preregistered or may be recognized based on the image acquired by the imaging part 10. The coordinates of articles large enough to conceal a person are referenced. The tracking part 14 calculates the distance between the directly-previous coordinates and the coordinates of the article. When the distance is less than a prescribed threshold, the tracking part 14 determines that the person is concealed in a shadow. When the person is determined to be concealed in a shadow in the second determination, the tracking part 14 performs the recovery processing.

The tracking part 14 may perform both the first and second determinations. The tracking part 14 performs the recovery processing when the person is determined to be concealed in a shadow in at least one of the first determination or the second determination.

By performing the first determination or the second determination, the recovery processing can be performed under more appropriate conditions. For example, if the movement speed of the person is high or the person is separated from articles when lost tracking occurs, it is likely that the person is already far away from where the person was when lost tracking occurred. If the recovery processing is performed when lost tracking occurred in a state in which the movement speed of the person is high or the person is separated from articles, the likelihood of being able to track the lost person again is low, and the lost person may be erroneously determined to be the same as another person. By performing the first determination or the second determination, the likelihood of erroneously determining the lost person to be the same as another person can be reduced.

When lost tracking occurs and the lost person is determined to be the same as a newly detected person, the person is deemed to have dwelled in the work area for the time that the person was not tracked as well. This time is tabulated as the dwell time.

When no person that can be deemed to be the same as the lost person is detected continuously for not less than a prescribed period after lost tracking occurred, the tracking part 14 registers the person as being in a lost state. The tracking part 14 stops the tracking for that person. Thereafter, the identification information of the lost person is not associated with persons detected in the image. When, however, the identifying part 13 re-identifies the lost person, the identification information is associated with the person; and the tracking is restarted.

When lost tracking occurs, the tracking part 14 may change the search range according to a change of the step count of the lost person. For example, the worker performs work while wearing a pedometer. The pedometer may be a pendulum type in which walking causes a pendulum to oscillate, or an acceleration sensor type that detects the acceleration caused by walking. A smart device may be used as the pedometer. The smart device is a smartphone, tablet, smartwatch, smart glasses, etc. The tracking part 14 tracks the person associated with the identification information and receives the step count from the pedometer of the person.

When lost tracking occurs, the tracking part 14 acquires the step count of the lost person. The tracking part 14 continues to acquire the step count of the lost person after lost tracking occurred. The tracking part 14 calculates the change of the step count after lost tracking. For example, the difference is calculated between the step count when acquiring the previous image 200 in which the person was last detected and a subsequent step count. The tracking part 14 increases the search range as the change of the step count increases.

For example, when the change of the step count is small, the tracking part 14 sets a narrower search range 203 as shown in FIG. 7A. When the change of the step count is large, the tracking part 14 sets a wider search range 203 as shown in FIG. 7B. When the change of the step count is large as shown in FIG. 7B, the vicinity of the coordinates 202 may be excluded from the search range 203. When a person not associated with the identification information is detected in the search range 203, the tracking part 14 deems that person to be the same as the lost person. By setting the search range according to the step count, the likelihood of erroneously determining that a lost person and another person are the same when lost tracking occurs for multiple persons can be reduced. The accuracy of the tracking can be increased.

The tracking part 14 may interrupt the recovery processing when the change of the step count is greater than a preset threshold. A large change of the step count indicates that the lost person has moved a lot. In other words, it is likely that the lost person no longer remains in the work area. By interrupting the recovery processing, the likelihood of erroneously determining the lost person and another person to be the same can be reduced. The accuracy of the tracking can be increased.

As an example, the stride length of a typical adult is about 0.7 m. When a margin of −40% to +20% is set, a radius R of the search range is determined by the following formula using a step count change S after being lost.

0.7×S×(1−0.4)<R<0.7×S×(1+0.2)

The negative margin is set to be greater than the positive margin because it is unlikely that the operator moves a lot while working.

It is also possible to calculate the movement distance of the worker based on a measured acceleration when a device that includes an acceleration sensor is attached to the worker. However, the accuracy of the movement distance calculated based on the acceleration is low. It is therefore difficult to restart the tracking of the lost person when the movement distance is used to search for the lost person. The inventor verified that the tracking of the lost person can be restarted with higher accuracy when the search range is set based on the step count than when the search range is set based on the movement distance calculated based on the acceleration.

As described above, the dwell time that is calculated by the calculator 16 can be deemed to be the work time. To reduce the difference between the dwell time and the actual work time, it is favorable to determine whether or not the person detected in the image is a worker. When persons other than the workers are present in the work site, it is likely that such persons are not performing work. The difference between the calculated dwell time and the actual work time increases if the time that such persons are present in the work area is tabulated as the dwell time. When a person is detected in the image, the detecting part 12 determines whether or not the detected person is a worker. The time that persons other than the workers are present in the work area is not included in the dwell time by the calculator 16. As a result, the dwell time that is calculated by the calculator 16 can better approach the actual work time.

For example, when a person is detected in the image, the detecting part 12 uses the appearance of the detected person to classify the person as being a worker or non-worker. Generally, a worker wears headwear (or a helmet), work clothes, gloves, work shoes, etc. A visitor that is not a worker does not wear headwear, work clothes, gloves, work shoes, etc. The appearance of the worker and the appearance of the visitor are different because the clothing of the worker and the clothing of the visitor are different. A pretrained classification model is used to classify the appearance. The classification model includes, for example, a neural network. It is favorable for the neural network to include a convolutional neural network (CNN) to classify with higher accuracy.

To increase the accuracy of the classification, a marker that indicates worker or non-worker may be used. For example, an AR marker is attached to the helmet of a worker. An AR marker is not attached to the helmet of a non-worker. Or, an AR marker that indicates a non-worker is attached. The detecting part 12 classifies the detected person by detecting the person and the AR marker in the image.

Or, data that indicates worker or non-worker may be pre-associated with the identification information of the person. When the identifier of an employee identification card is read by a reading device of the identifying part 13, data such as the person's affiliated department, occupation, job, etc., are pre-associated with the identification information of the identifier.

Or, data that indicates worker or non-worker may be associated with the identification information. The identifying part 13 determines whether or not the identified person is a worker based on the associated data. The identifying part 13 outputs the determination result of worker or non-worker together with the identification result of the person.

The calculator 16 may refer to a pre-generated work schedule to reduce the difference between the dwell time and the actual work time. The work time slots in which work is to be performed, the break time slots between work time slots, etc., are registered in the work schedule. It is estimated that a person is not performing work when the person dwells in a work area outside a work time slot. The time that the person dwells in the work area during a time slot other than a work time slot is not included in the dwell time by the calculator 16.

A shift schedule may be used as the work schedule. The work shift time slots and break time slots of employees are registered in the shift schedule. The work shift time slot corresponds to the work time slot. Operation data of devices used in the work may be used as the work schedule. Time slots when the devices operate and time slots when the devices are idle are registered in the operation data. A device operation time slot can be deemed to be a work time slot.

The calculator 16 may determine whether or not the detected person is moving. The calculator 16 calculates the movement speed of the person based on the tracking result of the tracking part 14. The calculator 16 determines that the person is moving when the movement speed is greater than a prescribed threshold. The time that a moving person dwells in the work area is not included in the dwell time by the calculator 16. As a result, the dwell time of persons simply passing through the work area can be prevented from being tabulated. The difference between the dwell time and the actual work time can be reduced.

When a person dwelling in a work area leaves the work area and then returns to the same work area within a prescribed period, the time from leaving the work area until returning to the work area may be tabulated as the dwell time by the calculator 16. For example, when equipment (tools, components, etc.) necessary for work are placed outside the work area, there are cases where the work area is temporarily left to fetch equipment. In such a case, the worker is substantially engaged in work in the work area even during the time away from the work area. By including the time away from the work area in the dwell time, the difference between the dwell time and the actual work time can be reduced. The time to be compared with the time spent away is modifiable as appropriate according to the size of the work area, the shape of the work area, the specific layout of the work site, etc.

When a passageway is a part of the work area, the region of the passageway and the other regions may be discriminated. For example, when the color of the floor surface of the passageway is different from the colors of the floor surfaces of the other regions, the recognizing part 15 uses the color difference to recognize the passageway included in the work area. The recognizing part 15 excludes the passageway from the recognized work area. The calculator 16 calculates the dwell time of the persons present in work areas other than passageways. Other than the color of the floor surface being different from the colors of the other regions, the outer edges of the passageway may be colored differently from the surroundings. For example, colored tape may be adhered to the outer edges of the passageway.

Or, the coordinates of the passageway may be preset. For example, a passageway is designated in the image 152 displayed in the GUI 151 shown in FIG. 3. The recognizing part 15 refers to the coordinates of the designated passageway and recognizes the passageway included in the work area. The recognizing part 15 excludes the recognized passageway from the work area.

Or, segmentation of the image may be performed to classify passageways and work areas other than passageways. The image that is issued by the issuing part 11 is input by the recognizing part 15 to a segmentation model trained to segment into passageways and other regions. The issuing part 11 subdivides the input image into multiple objects. Segmentation is used to subdivide the image into objects corresponding to passageways and objects other than passageways. The regions identified as passageways are excluded from the recognized work areas by the recognizing part 15. The segmentation model includes a neural network. It is favorable for the neural network to include a CNN to increase the segmentation accuracy.

The calculator 16 may correct the calculated dwell time based on the estimated work time in which work is estimated to have been performed. For example, in the case of a worker that constantly works in the work site, the estimated work time is calculated based on the worker's attendance records. The total of the time from the start of the workday to a break and the time from the break to the end of the workday corresponds to the estimated work time. The estimated work time may be calculated based on the work schedule, etc. For example, the time in the work schedule spent in the work site during the time from the shift start to the break and the time from the break to the shift end corresponds to the estimated work time.

When the worker appropriately performs the work and the dwell time is accurately calculated by the processing system 1, the calculated dwell time is equal to the estimated work time. When there is a difference between the calculated dwell time and the estimated work time, the calculator 16 corrects the dwell time to reduce the difference. In such a case, the calculator 16 corrects the dwell time while maintaining the dwell time ratio in each work area.

Specifically, first, the calculator 16 refers to the dwell time of one person in each work area. Then, the calculator 16 calculates the ratio of the estimated work time of the person to the total dwell time. The ratio is “1” when the total dwell time and the estimated work time are equal. The ratio is less than 1 when the total dwell time is greater than the estimated work time. The ratio is greater than 1 when the total dwell time is less than the estimated work time. The calculator 16 multiplies the dwell time in each work area by the ratio. The corrected dwell times are obtained thereby.

For example, when an object that is not a person is erroneously detected as a person by the detecting part 12 or when a person is not detected, a difference occurs between the dwell time and the estimated work time. On the other hand, considering that misdetections by the detecting part 12 occur at a certain probability and at random timing, the ratio of the dwell time in each work area is expected to be substantially accurate. Therefore, the calculator 16 multiplies the dwell time in each work area by the ratio described above. As a result, the dwell times are corrected while maintaining the ratio of the dwell time in each work area. The difference between the dwell time and the actual work time can be reduced.

As an example, the calculator 16 calculates that a worker dwelled in the work areas 101 to 103 shown in FIG. 2 for 3 hours each. On the other hand, based on the attendance record of the worker, it is estimated that work was performed for 7.2 hours. In such a case, the ratio of the estimated work time to the total dwell time is 0.8. The calculator 16 multiplies the dwell time (3 hours) of each of the work areas 101 to 103 by a ratio of 0.8. As a result, the dwell time is corrected to 2.4 hours for each of the work areas 101 to 103.

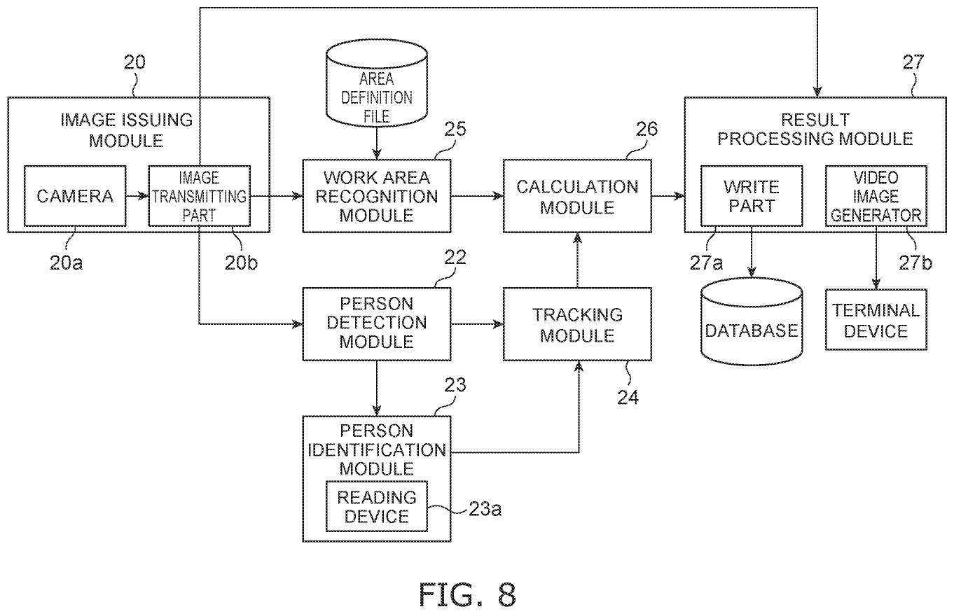

FIG. 8 is a schematic view showing a configuration example of the processing system according to the embodiment.

The processing system 1 shown in FIG. 1 is implemented as a system that includes an image issuing module 20, a person detection module 22, a person identification module 23, a tracking module 24, a work area recognition module 25, a calculation module 26, and a result processing module 27 shown in FIG. 8.

The image issuing module 20 includes a camera 20a and an image transmitting part 20b. The image transmitting part 20b is a software program located in a processing server. The image transmitting part 20b receives an image that is imaged by the camera 20a. The camera 20a and the image transmitting part 20b are connected by a communication line of the Ethernet standard or the USB standard. To transmit the images to the other modules, the image transmitting part 20b streams the images on a local area network (LAN) accessible by the other modules.

The person detection module 22 is a software program implemented by an arithmetic device, and includes a person detection model including a convolutional neural network. The person detection module 22 inputs the image issued by the image issuing module to the person detection model and acquires the coordinates of the persons visible in the image. The acquired coordinates are published in the Web API format on a LAN accessible by the other modules.

The person identification module 23 includes a reading device 23a. The reading device 23a is mounted at the vicinity of the work site entrance/exit. The reading device 23a is positioned within the angle of view of the camera 20a. The coordinates of the reading device 23a in the image are preregistered. When entering the work site, the worker reads the employee identification card into the reading device 23a. The person identification module 23 associates the read identification information with the person most proximate to the reading device 23a among the persons detected by the person detection module 22. The identification information that is acquired by the person identification module 23 is published in the Web API format on a LAN accessible by the other modules.

The tracking module 24 acquires the detection result of the person detection module 22 and the identification result of the person identification module 23 and starts the tracking with the individual identified. In tracking, the coordinates of the persons received from the person detection module 22 are referenced; and the persons of which the coordinates are most proximate or the features match best in consecutive frames are recognized as being respectively the same; and the coordinates of the persons are tracked.

The work area recognition module 25 recognizes the work areas by using, in parallel, work area information obtained by reading an area definition file prepared beforehand and work area information obtained by recognizing markers located in the work site. Specifically, the work area recognition module 25 recognizes, as the work areas, the sum of the work areas obtained from the area definition file and the work areas obtained based on the markers. For example, when one part of the work site is not included in the work areas obtained from the area definition file but is included in the work areas obtained based on the markers, the part is recognized as a work area. The coordinate data of the recognized work areas is published in Web API format on a LAN accessible by the other modules. Also, the work area recognition module 25 publishes, to a database or Web API on a LAN, data in JSON format in which the work to be performed is associated with the recognized work areas.

When the sum of the work areas obtained from the area definition file and the work areas obtained based on the markers is recognized as the work areas, there are cases where one work area and another work area overlap. When different work is performed in the overlapping work area, it cannot be discriminated which work is performed in the overlapping part when deeming the dwell time to be work time. When work areas overlap each other and different work is performed in the work areas, the work area recognition module 25 may issue a notification to the result processing module 27. The result processing module 27 outputs the notification to the user. For example, the result processing module 27 transmits a message to a prescribed terminal and/or mail to a prescribed address. If common work is performed in overlapping work areas, the dwell time in the overlapping part may be deemed to be dwell time in either work area. Therefore, the work area recognition module 25 mayor may not issue a notification.

The calculation module 26 calculates the dwell time of each person in each work area based on the tracking result from the tracking module 24 and the work area recognition result from the work area recognition module 25.

The result processing module 27 includes a write part 27a and a video image generator 27b. The write part 27a and the video image generator 27b are software programs located in a processing server. The write part 27a performs database communication and writes data to an external database server by using Open Database Connectivity (ODBC), etc. The write part 27a may use a prescribed format such as comma-separated values (CSV) or the like to write the dwell time of each work area to a recording medium such as a hard disk drive (HDD), an SD card, etc.

The video image generator 27b generates a video image showing the dwell time of each work area by overlapping the video image that is imaged by the camera 20a, the work area recognition result from the work area recognition module 25, and the calculation result from the calculation module 26. The video image generator 27b outputs the generated video image in a format such as MP4, WMV, AVI, etc. The video image generator 27b may use Hypertext Transfer Protocol (http) or Real Time Streaming Protocol (rtsp) to stream the video image. Also, the result processing module 27 may transmit data to an external server by using File Transfer Protocol (FTP), etc.

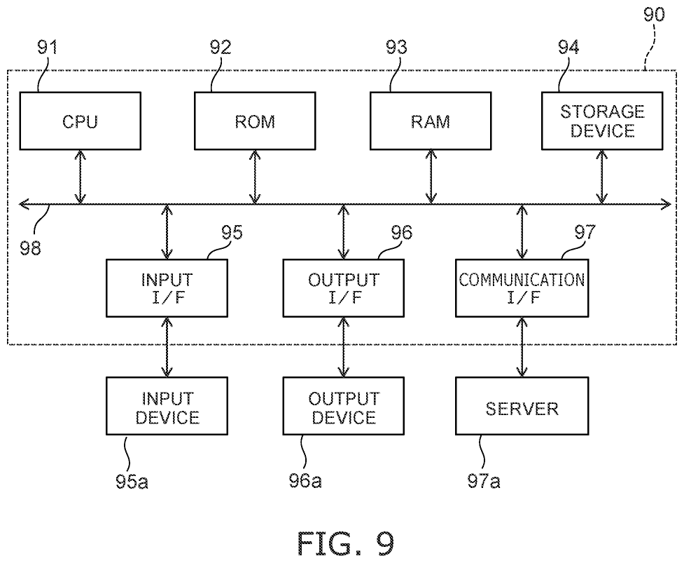

FIG. 9 is a schematic view illustrating a hardware configuration.

The image issuing module 20, the person detection module 22, the person identification module 23, the tracking module 24, the work area recognition module 25, the calculation module 26, and the result processing module 27 shown in FIG. 8 each include, for example, a computer 90 (a processing device) shown in FIG. 9. The computer 90 includes a CPU 91, ROM 92, RAM 93, a storage device 94, an input interface 95, an output interface 96, and a communication interface 97.

The ROM 92 stores programs that control the operations of the computer. Programs that are necessary for causing the computer to realize the processing described above are stored in the ROM 92. The RAM 93 functions as a memory region into which the programs stored in the ROM 92 are loaded.

The CPU 91 includes a processing circuit. The CPU 91 uses the RAM 93 as work memory to execute the programs stored in at least one of the ROM 92 or the storage device 94. When executing the programs, the CPU 91 executes various processing by controlling configurations via a system bus 98.

The storage device 94 stores data necessary for executing the programs and/or data obtained by executing the programs.

The input interface (I/F) 95 connects the computer 90 and an external input device 95a. The input I/F 95 is, for example, a serial bus interface such as USB, etc. The CPU 91 can read various data from the input device 95a via the input I/F 95.

The output interface (I/F) 96 connects the computer 90 and an external output device 96a. The output I/F 96 is, for example, an image output interface such as Digital Visual Interface (DVI), High-Definition Multimedia Interface (HDMI (registered trademark)), etc. The CPU 91 can transmit data to the output device 96a via the output I/F 96 and can cause the output device 96a to display an image.

The communication interface (I/F) 97 connects an external server 97a and the computer 90. The communication I/F 97 is, for example, a network card such as a LAN card, etc. The CPU 91 can read various data from the server 97a via the communication I/F 97.

The storage device 94 includes at least one selected from a hard disk drive (HDD) and a solid state drive (SSD). The input device 95a includes at least one selected from a mouse, a keyboard, a microphone (audio input), and a touchpad. The output device 96a includes at least one selected from a monitor, a projector, a speaker, and a printer. A device such as a touch panel that functions as both the input device 95a and the output device 96a may be used.

The functions of the image issuing module 20, the person detection module 22, the person identification module 23, the tracking module 24, the work area recognition module 25, the calculation module 26, and the result processing module 27 may be realized by one computer or may be realized by the collaboration of two or more computers. For example, one computer 90 may function as the modules described above. One computer 90 may function as a part of the modules described above; and another computer 90 may perform the other functions. In such a case, the one computer 90 and the other computer 90 may transmit and receive data via a network.

As an example, a calculating device that functions as the calculation module 26 is prepared. The calculating device has the configuration of the computer 90. The calculating device acquires the result of a person visible in an image being tracked in a state of being associated with identification information. The calculating device refers to work areas set in a work site visible in the image. The calculating device also calculates the dwell times of the persons in the work areas by using the tracking result. The calculating device also may function as at least one selected from the image issuing module 20, the person detection module 22, the person identification module 23, the tracking module 24, the work area recognition module 25, the calculation module 26, and the result processing module 27.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD±R, DVD±RW, etc.), semiconductor memory, or another non-transitory computer-readable storage medium.

For example, the information that is recorded in the recording medium can be read by the computer (or an embedded system). The recording format (the storage format) of the recording medium is arbitrary. For example, the computer reads the program from the recording medium and causes a CPU to execute the instructions recited in the program based on the program. In the computer, the acquisition (or the reading) of the program may be performed via a network.

Inventions according to embodiments may include the following features.

### Feature 1

A processing system, comprising:
an imaging part acquiring an image by imaging a work site from above;
a detecting part acquiring a coordinate of a person visible in the image by detecting the person in the image;
an identifying part identifying the person and associating identification information with the detected person;
a tracking part tracking the person associated with the identification information by using the coordinate; and
a calculator calculating a dwell time of the person in a work area by using a result of the tracking,
the work area being set in the work site.

### Feature 2

The processing system according to Feature 1, wherein
the detecting part detects each of a plurality of the persons when the plurality of persons is visible in the image,
the identifying part associates a plurality of the identification information respectively with the plurality of persons,
the tracking part tracks each of the plurality of persons, and
the calculator calculates the dwell times that each of the plurality of persons dwells in each of a plurality of the work areas.

### Feature 3

The processing system according to Feature 1, wherein
the imaging part acquires a plurality of the images including a first image, a second image, and a third image,
the third image is acquired after the first image,
the second image is acquired between the first image and the third image,
when the person is detected in the first and third images but not in the second image, the tracking part performs recovery processing including:
   setting a prescribed range referenced to the coordinate of the person in the first image;
   calculating a time difference between a time at which the first image is acquired and a time at which the third image is acquired; and
   deeming the person visible in the third image to be the same as the person visible in the first image when the coordinate of the person in the third image is within the range and the time difference is less than a prescribed threshold.

### Feature 4

The processing system according to Feature 3, wherein
the tracking part associates, with the person visible in the third image deemed to be the same, the identification information associated with the person visible in the first image.

### Feature 5

The processing system according to Feature 3 or 4, wherein
the tracking part changes the range according to a change of a step count of the person after the first image is acquired.

### Feature 6

The processing system according to Feature 5, wherein
the tracking part stops tracking the person when the change of the step count is greater than a prescribed threshold.

### Feature 7

The processing system according to any one of Features 3 to 6, wherein
the tracking part calculates a movement speed of the person by using the time at which the first image is acquired and the coordinate of the person in the first image, and
the tracking part performs the recovery processing when the movement speed is less than a prescribed threshold.

### Feature 8

The processing system according to any one of Features 3 to 6, wherein
the tracking part calculates a distance between the coordinate of the person in the first image and a coordinate of an article in the work site, and
the tracking part performs the recovery processing when the distance is less than a prescribed threshold.

### Feature 9

The processing system according to any one of Features 3 to 8, wherein
the tracking part stops tracking the person when a state in which the person is not detected continues for not less than a prescribed period.

### Feature 10

The processing system according to any one of Features 1 to 9, further comprising:
a recognizing part recognizing the work area in the image,
the recognizing part recognizing the work area by using a marker visible in the image or a coordinate of the work area, the coordinate of the work area being preset.

### Feature 11

The processing system according to Feature 10, wherein
the recognizing part also recognizes a passageway included in the work area, and
a time that the person dwells in the passageway is not included in the dwell time.

### Feature 12

The processing system according to any one of Features 1 to 11, wherein
the detecting part determines whether or not the person visible in the image is a worker, and
the calculator does not include, in the dwell time, a time that the person other than a worker dwells in the work area.

### Feature 13

The processing system according to any one of Features 1 to 12, wherein
the calculator refers to a work time slot in which work is to be performed in the work area, and does not include, in the dwell time, a time that the person dwells in the work area during a time slot other than the work time slot.

### Feature 14

The processing system according to any one of Features 1 to 13, wherein
the calculator does not include, in the dwell time, a time in which the person dwells in the work area and moves at not less than a prescribed speed.

### Feature 15

The processing system according to any one of Features 1 to 14, further comprising:
an output part displaying an object overlaid on the image and displaying the dwell time associated with the object, the object indicating the work area.

### Feature 16

The processing system according to any one of Features 1 to 15, wherein
the output part is configured to display a user interface,
the image is displayed in the user interface, and
the output part sets a coordinate of the work area based on an input of a user for the image.

According to the embodiments described above, a processing system, a calculating device, a processing method, a program, and a storage medium are provided in which a dwell time of a person in a work area can be calculated more easily and with less time and effort.

According to the tracking method that includes the recovery processing described in the embodiment, the tracking of a person can be restarted with higher accuracy even when losing track of the person. In particular, when lost tracking occurs in a work site, the tracking of the lost person can be restarted with higher accuracy.

While certain embodiments of the inventions have been illustrated, these embodiments have been presented by way of example only, and are not intended to limit the scope of the inventions. These novel embodiments may be embodied in a variety of other forms; and various omissions, substitutions, modifications, etc., can be made without departing from the spirit of the inventions. These embodiments and their modifications are within the scope and spirit of the inventions and are within the scope of the inventions described in the claims and their equivalents. The embodiments described above can be implemented in combination with each other.

What is claimed is:

1. A processing system, comprising:
an imaging part acquiring an image by imaging a work site from above;
a detecting part acquiring a coordinate of a person visible in the image by detecting the person in the image;
an identifying part identifying the person and associating identification information with the detected person;
a tracking part tracking the person associated with the identification information by using the coordinate; and
a calculator calculating a dwell time of the person in a work area by using a result of the tracking,
the work area being set in the work site.

2. The system according to claim 1, wherein
the detecting part detects each of a plurality of the persons when the plurality of persons is visible in the image,
the identifying part associates a plurality of the identification information respectively with the plurality of persons,
the tracking part tracks each of the plurality of persons, and
the calculator calculates the dwell times that each of the plurality of persons dwells in each of a plurality of the work areas.

3. The system according to claim 1, wherein
the imaging part acquires a plurality of the images including a first image, a second image, and a third image,
the third image is acquired after the first image,
the second image is acquired between the first image and the third image,
when the person is detected in the first and third images but not in the second image, the tracking part performs recovery processing including:
setting a prescribed range referenced to the coordinate of the person in the first image;
calculating a time difference between a time at which the first image is acquired and a time at which the third image is acquired; and
deeming the person visible in the third image to be the same as the person visible in the first image when the coordinate of the person in the third image is within the range and the time difference is less than a prescribed threshold.

4. The system according to claim 3, wherein
the tracking part associates, with the person visible in the third image deemed to be the same, the identification information associated with the person visible in the first image.

5. The system according to claim 3, wherein
the tracking part changes the range according to a change of a step count of the person after the first image is acquired.

6. The system according to claim 5, wherein
the tracking part stops tracking the person when the change of the step count is greater than a prescribed threshold.

7. The system according to claim 3, wherein
the tracking part calculates a movement speed of the person by using the time at which the first image is acquired and the coordinate of the person in the first image, and
the tracking part performs the recovery processing when the movement speed is less than a prescribed threshold.

8. The system according to claim 3, wherein
the tracking part calculates a distance between the coordinate of the person in the first image and a coordinate of an article in the work site, and
the tracking part performs the recovery processing when the distance is less than a prescribed threshold.

9. The system according to claim 3, wherein
the tracking part stops tracking the person when a state in which the person is not detected continues for not less than a prescribed period.

10. The system according to claim 1, further comprising:
a recognizing part recognizing the work area in the image,
the recognizing part recognizing the work area by using a marker visible in the image or a coordinate of the work area,
the coordinate of the work area being preset.

11. The system according to claim 10, wherein
the recognizing part also recognizes a passageway included in the work area, and
a time that the person dwells in the passageway is not included in the dwell time.

12. The system according to claim 1, wherein
the detecting part determines whether or not the person visible in the image is a worker, and
the calculator does not include, in the dwell time, a time that the person other than a worker dwells in the work area.

13. The system according to claim 1, wherein
the calculator refers to a work time slot in which work is to be performed in the work area, and does not include, in the dwell time, a time that the person dwells in the work area during a time slot other than the work time slot.

14. The system according to claim 1, wherein
the calculator does not include, in the dwell time, a time in which the person dwells in the work area and moves at not less than a prescribed speed.

15. The system according to claim 1, further comprising:
an output part displaying an object overlaid on the image and displaying the dwell time associated with the object,
the object indicating the work area.

16. The system according to claim 15, wherein
the output part is configured to display a user interface,
the image is displayed in the user interface, and
the output part sets a coordinate of the work area based on an input of a user for the image.

17. A calculating device, configured to:
acquire a result of tracking in a state in which a person visible in an image is associated with identification information;
refer to a work area set in a work site visible in the image; and
calculate a dwell time of the person in the work area by using the result of the tracking.

18. A processing method, comprising:
acquiring an image by imaging a work site from above;
detecting a person visible in the image;
acquiring a coordinate of the person in the image;
identifying the person and associating identification information with the detected person;
tracking the person associated with the identification information by using the coordinate; and
calculating a dwell time of the person in a work area set in the work site by using a result of the tracking.

19. A tracking method,
when tracking a person visible in images, and when a third image is acquired after a first image, a second image is acquired between the first image and the third image, and the person is detected in the first and third images but not in the second image, the method comprising:
setting a prescribed range referenced to a coordinate of the person in the first image;
calculating a time difference between a time at which the first image is acquired and a time at which the third image is acquired; and
when the coordinate of the person in the third image is within the range and the time difference is less than a prescribed threshold, restarting the tracking by deeming the person visible in the third image to be the same as the person visible in the first image.

20. A non-transitory computer-readable storage medium, configured to:
store a program,
the program causing a computer to execute the processing method according to claim 18.
